(19) United States
(12) Patent Application Publication
(10) Pub. No.: US 2017/0332844 A1
(43) Pub. Date: Nov. 23, 2017

(54) APPLIANCE WITH INTEGRATED AGITATOR ASSEMBLY

(71) Applicant: SUNBEAM PRODUCTS, INC., Boca Raton, FL (US)

(72) Inventors: Moises Behar, Boca Raton, FL (US); Joseph C. Spencer, Jr., Purvis, MS (US)

(73) Assignee: SUNBEAM PRODUCTS, INC., Boca Raton, FL (US)

(21) Appl. No.: 15/525,529

(22) PCT Filed: Nov. 11, 2015
(86) PCT No.: PCT/US2015/060095

§ 371 Date: May 9, 2017

Related U.S. Application Data
(60) Provisional application No. 62/077,982, filed on Nov. 11, 2014.

(51) Int. Cl. A47J 43/07; B01F 15/00; A47J 43/046; B01F 7/00; A47J 43/06; A47J 43/044

(52) U.S. Cl. CPC A47J 43/0722; B01F 7/00275; A47J 43/06; B01F 15/00772; B01F 15/00538; A47J 43/046; A47J 43/0766; A47J 2043/0449; B01F 2015/00084

(57) ABSTRACT

The is provided an appliance including a food preparation container, an agitator assembly for attachment to a blending container, the agitator assembly including: an agitator nut configured to secure the agitator assembly to the blending container, an agitator base including at least one agitator blade mounted thereon and configured to be seated in the agitator nut prior to the agitator assembly being secured to the blending container, a groove formed in an inner wall of the agitator nut, and a seal having an outer periphery that when inserted into the groove secures the agitator base into the agitator nut.

### RELATED APPLICATIONS

This application claims the benefit of U.S. provisional patent application Ser. No. 62/077,982 filed on Nov. 11, 2014.

### FIELD OF THE INVENTION

The invention relates to food preparation and more particularly to a food preparation appliance with an agitator assembly that may be assembled into an integrated one-piece unit for easy installation on a food preparation container of a food preparation appliance.

### BACKGROUND OF THE INVENTION

Food preparation appliances such as blending appliances are known in the art. Typically, such appliances include a housing containing a motor-fan assembly, a blending container and an agitator assembly rotated by the motor-fan assembly. The agitator assembly is usually comprised of three pieces: an agitator nut, an agitator base with one or more agitator blades, and a seal. These components must each be assembled separately on the blending container before the entire assembly is secured to the blending container with the agitator nut which may be cumbersome for the consumer.

### SUMMARY OF THE INVENTION

In an embodiment, there is provided an appliance including a food preparation container, an agitator assembly for attachment to a blending container, the agitator assembly including: an agitator nut configured to secure the agitator assembly to the blending container, an agitator base including at least one agitator blade mounted thereon and configured to be seated in the agitator nut prior to the agitator assembly being secured to the blending container, a groove formed in an inner wall of the agitator nut, and a seal having an outer periphery that when inserted into the groove secures the agitator base into the agitator nut.

In an embodiment, there is provided an agitator assembly for a blending container, including an agitator nut configured to secure the agitator assembly to the blending container, an agitator base including at least one agitator blade mounted thereon and configured to be seated in the agitator nut prior to the agitator assembly being secured to the blending container, a groove formed in an inner wall of the agitator nut, and a seal having an outer periphery that when inserted into the groove secures the agitator base into the agitator nut

In an embodiment, there is provided a method of constructing an agitator assembly for a blending container, including providing an agitator base including at least one agitator blade mounted thereon, seating the agitator base in the agitator nut prior to the agitator assembly being secured to the blending container, and securing the agitator base into the agitator nut by inserting a seal having an outer periphery that when inserted into a groove formed in a sidewall of the agitator nut.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front perspective view of an embodiment of a blending jar with an integrated agitator assembly for use with a blending appliance;

FIG. 2 is an exploded perspective view thereof;

FIG. 3 is a front perspective view of the integrated agitator assembly of FIG. 1; and

FIG. 4 is a sectional view thereof.

### DETAILED DESCRIPTION OF THE INVENTION

An integrated agitator assembly for a blending container of a blending appliance The agitator assembly includes an agitator nut, agitator base with dual agitator blades, and a seal that fits into a groove in the agitator nut to secure the agitator base into the agitator nut forming an integrated one-piece agitator assembly than can easily be installed on the blending container. The seal can also be removed from the groove in the agitator nut to release the agitator base from the agitator nut so that all of the components of the agitator assembly may be cleaned or replaced as needed.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention.

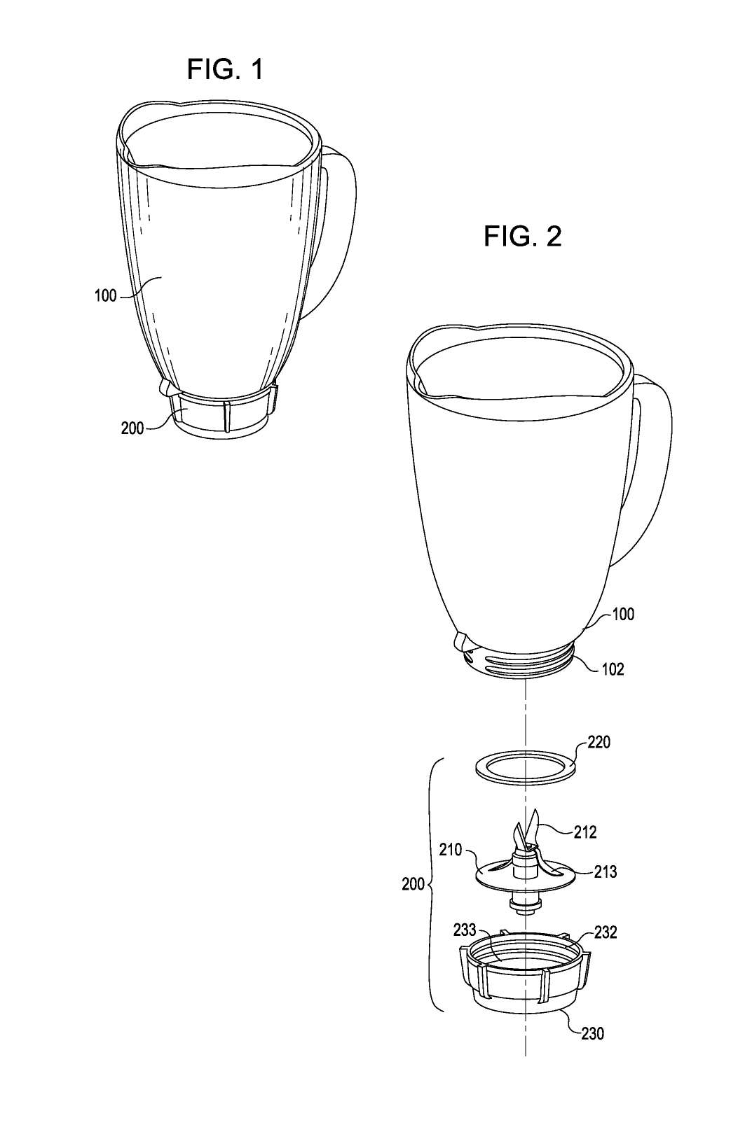

Referring now to FIGS. 1 and 2, there is illustrated a blending container 100 for holding ingredients for blending a blended beverage such as juices, mixed drinks, slushies, soups, etc. The blending container 100 may be sized as shown in the illustration for preparing multiple servings of a blended beverage or may be sized for preparing a single serving of a blended beverage. The blending container 100 may be formed from any suitable material such as glass, plastic, metal, etc., and may be fitted with a lid (not shown) for preventing spillage of the contents. An agitator assembly 200 is disposed at the bottom of the blending container 100 for agitating contents placed into the blending container 100. The agitator assembly 200 is configured to be mounted on a motorized base (not shown) which provides rotary power to the agitator assembly 200. The agitator assembly 200 includes an agitator nut 230, a seal 220 and an agitator base 210. The seal 220 is annular shaped with a bole in the center and an outer periphery which are separated by a strip of material of a finite width. The seal 220 is made from a resilient material such as rubber or plastic so that it may be installed in the agitator nut 230.

One or more agitator blades 212, 213 may be mounted on the agitator base 210. For example, agitator blade 212 may be mounted on top of agitator blade 213. The agitator blade 212 may be comprised of a pair of upwardly disposed diametrically opposed blade sections and the agitator blade 213 may be comprised of downwardly disposed diametrically opposed blade sections. The exact number of agitator blades and their configurations is not meant to be limiting in any sense since any number and/or configuration of agitator blades is possible. The agitator assembly 200 with agitator base 210 and agitator blades 212, 213 is mounted on the bottom of the blending container 100 via threads 232 on the agitator nut 230 which engage complementary threads 102 on the bottom of the blending container 100.

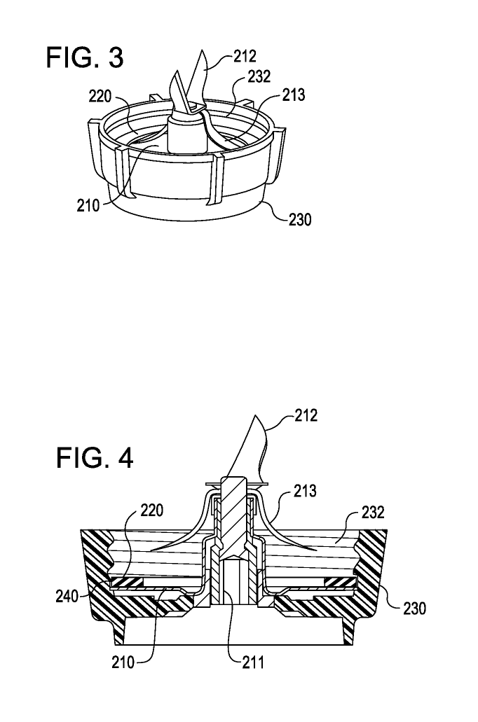

Referring now also to FIGS. 3 and 4, the agitator base 210 and agitator blades 212, 213 may be secured inside the agitator nut 230 by 1) inserting the agitator base 210 into the interior of the agitator nut 230; 2) installing the seal 220 over the agitator base 210 by inserting the agitator blades 212, 213 through the hole in the center of the seal 220; and 4) inserting the outer periphery of the seal 220 into a groove 240 formed in the inner wall of the agitator nut 230 beneath the threads 232. The resulting integrated one-piece agitator assembly 200 may be installed on the blending container 100 more easily than installing all the components separately. The blending container 100 and agitator assembly 200 may be installed on a motorized base (not shown) by coupling a keyed or splined socket 211 on the agitator assembly 200 with a complementary keyed or splined shaft (not shown) on the motorized base (not shown). The integrated one-piece agitator assembly 200 may be also quickly and easily be disassembled into separate components for cleaning or repair by removing the seal 220 from the groove 240 which releases the agitator base 210 from the agitator nut 230.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An appliance, comprising:
a food preparation container;
an agitator assembly for attachment to a blending container, the agitator assembly including:
an agitator nut configured to secure the agitator assembly to the blending container;
an agitator base including at least one agitator blade mounted thereon and configured to be seated in the agitator nut prior to the agitator assembly being secured to the blending container;
a groove formed in an inner wall of the agitator nut; and
a seal having an outer periphery that when inserted into the groove secures the agitator base into the agitator nut.

2. The appliance of claim 1, further including threads on an inner wall of the agitator nut disposed above the groove configured to mate with complementary threads formed on an end of the blending container.

3. An agitator assembly for a blending container, comprising:
an agitator nut configured to secure the agitator assembly to the blending container;
an agitator base including at least one agitator blade mounted thereon and configured to be seated in the agitator nut prior to the agitator assembly being secured to the blending container;
a groove formed in an inner wall of the agitator nut; and
a seal having an outer periphery that when inserted into the groove secures the agitator base into the agitator nut.

4. The agitator assembly of claim 3, further including:
threads on an inner wall of the agitator nut disposed above the groove configured to mate with complementary threads formed on an end of the blending container.

5. A method of constructing an agitator assembly for a blending container, comprising:
providing an agitator base including at least one agitator blade mounted thereon;
seating the agitator base in the agitator nut prior to the agitator assembly being secured to the blending container; and
securing the agitator base into the agitator nut by inserting a seal having an outer periphery into a groove formed in an inner wall of the agitator nut.
